(19) United States
(12) Patent Application Publication
(10) Pub. No.: US 2014/0259932 A1
(43) Pub. Date: Sep. 18, 2014

(54) WIDE-SPAN LOUVER

(71) Applicant: Royal GROUP, INC., Woodbridge (CA)

(72) Inventors: Brian STAFFORD, Bristol, VA (US); Daniel SUASNABAR, Rancho Cucamonga (AU); Brandon NADLER, Abingdon, VA (US)

(73) Assignee: Royal GROUP, INC., Woodbridge (CA)

(21) Appl. No.: 14/211,514

(22) Filed: Mar. 14, 2014

Related U.S. Application Data
(60) Provisional application No. 61/784,427, filed on Mar. 14, 2013.

(51) Int. Cl. E06B 7/084

(52) U.S. Cl. CPC E06B 7/084
USPC 49/92.1

(57) ABSTRACT

Wide span louvers including elongated oval bodies with a thickness to width ratio between 0.14 to 0.25, and a pivot/attachment point offset below the horizontal axis, and other improvements to improve resistance to weight and/or thermal sag in long span shutter assemblies and the like.

### CROSS REFERENCE TO RELATED APPLICATION

The present application claims the benefit of priority of U.S. Provisional Patent Application No. 61/784,442 filed Mar. 14, 2014, which is incorporated herein by reference.

### BACKGROUND OF THE INVENTION

Traditional poly-vinyl chloride (“PVC”) plastic louvers installed in a shutter panel will deflect/sag under their own weight. If the deflection of the louver becomes too great, the sag becomes visibly apparent. The visibility of the sagging is compounded in the shutter panel because the multiple louvers create numerous parallel lines, so even a small deflection can be very apparent and aesthetically undesirable. This is further compounded when traditional PVC plastic louvers are used for wide spans. Many current shutter panels on the market are no greater than 30 inches wide, with a 26 inch louver span to reduce or prevent visible sagging of the louvers.

Current wide-span louver designs are composed of a PVC with aluminum inserts, to provide added strength. The PVC and aluminum insert is extruded together to form composite lover in a cross-head extrusion manufacturing process. This is undesirable for several reasons, including:
the cross-head extrusion process is costly;
the aluminum insert is visible on ends of louver blade resulting in compromised aesthetics of the shutter panel;
special handling is required for the mixed PVC/aluminum dust and scrap created during sawing louvers to size;
the aluminum insert is a thermal conductor which can accelerate heat distortion and shrinkage of the PVC when exposed to solar or other thermal energy;
the aluminum insert causes marking and scratching during the fabrication process;
imported wide-span lovers using aluminum inserts may be of dubious quality.

Wide-span louvers of the invention may offer significant cost advantage over current wide-span louvers by using a homogeneous material with no aluminum insert, while maintaining the conventional/traditional aesthetic as closely as possible. In addition, the homogeneous nature of wide-span louvers of the invention may minimize requirements for machining and handling dust and scrap.

### SUMMARY OF THE INVENTION

In view of the foregoing, it is a feature of the embodiments described herein to provide a louver that provides an improved capability to span wide windows without the sagging or cost of current louvers. In various embodiments, the wide span louvers of the invention may include one or more of a new profile geometry, increased thickness, a reinforcement rib portion, an offset pivot point, and/or an improved PVC compound. One benefit of embodiments of the wide-span louvers of the invention may be that the wide-span louvers have increased spanning capability with minimal sagging due to weight. Another benefit of embodiments of the wide span louvers of the invention may be that the wide-span louvers have an increased resistance to thermal deformation, such as heat sag.

The amount of deflection a louver will experience is accurately described by beam stress and deflection calculations from the field of engineering mechanics of deformable bodies, such as engineering science of materials, engineering mechanics of materials, and engineering strength of materials. There are two bending scenarios: beam deflection with simply supported ends and beam deflection with fixed ends. Typically, deflection in beams with fixed ends is less than beams with simply supported ends. The design of hardware used to fabricate the shutter can influence which stress and deflection equations will apply fixed ends, or simply supported ends. Hardware used in embodiments of the invention should be such that it results in a fixed end scenario to minimize deflection.

For a beam (louver) with fixed ends, the maximum deflection is described by the beam equation:

y=WL³/384EI

Where: “y” is the calculated deflection at the center of the beam, “W” is the total load on the beam, “L” is the length or span of the louver, “E” is the Modulus of Elasticity of the louver and “I” is the cross sectional moment of inertia of the louver.

For a cellular PVC louver profile the variables in the beam equation which may be controlled to reduce sagging/deflection in the embodiments of the wide-span louvers of the invention may include: the total load, the modulus of elasticity and the cross sectional moment of inertia.

The total load applied to the beam, in this case the weight of the louver, is a function of the specific gravity of the cellular PVC material. Specific gravity can be controlled by the foaming agent and process conditions used in the extrusion process.

The modulus of elasticity is a function of the PVC compound formulation and the specific gravity of the louver. The compound formulation selected shall be a composite of PVC and other thermoset plastics used to increase the modulus above that of common PVC compounds. Materials that may be used to increase the modulus of elasticity include acrylic, styrene, SAN, AMSAN, CPVC, and others described later in this disclosure.

The cross sectional moment of inertia is a function of the geometry of the louver, and the location of the bending axis relative to the neutral axis (i.e. the axis of symmetry) of the louver. Offsetting the bending axis (in this case the pivot point of the louver) from the neutral axis of the profile will increase the moment of inertia. The overall geometry can be changed to increase the moment of inertia, but some embodiments of the invention will be constrained such that the louver and assembled shutter retain a visual aesthetic similar to traditional louvers.

Embodiments of the wide-span louvers of the invention may include a combination of one or more of thicker cross sections, offset pivot points, an integrated rib shape, a curved shape profile and/or use a high density PVC compound to achieve greater span lengths while minimizing sagging.

### BRIEF DESCRIPTION OF THE DRAWINGS

Purposes and advantages of the exemplary embodiments will be apparent to those of ordinary skill in the art from the following detailed description in conjunction with the appended drawings in which like reference characters are used to indicate like elements, and in which:

FIG. 1 is a cross-sectional view of a shutter including prior art louvers;

FIG. 2A is a cross-sectional plan view of a shutter including an embodiment of the louvers of the invention;

FIG. 2B is a cross-sectional perspective view of a shutter including an embodiment of the louvers of the invention;

FIG. 3 is a cross-sectional view of a shutter including an alternative embodiment of the louvers of the invention;

FIG. 4 is a dimensional cross-section view of a preferred embodiment of the louvers of the invention;

FIG. 5 is a schematic view of a beam with fixed ends undergoing a load;

FIG. 6A is a cross-sectional view of a prior art louver;

FIG. 6B is a cross-sectional view of a an embodiment of the louvers of the invention;

FIG. 6C is a cross-sectional view of a preferred embodiment of the louvers of the invention;

FIG. 7A is a dimensional cross-sectional view of a prior art louver;

FIG. 7B is a dimensional cross-sectional view of a prior art louver including a cap-stock/reinforcing external skin layer;

FIG. 7C is a dimensional cross-sectional view of an alternative embodiment louver with an “S” shaped profile;

FIG. 7D is a dimensional cross-sectional view of a second alternative embodiment louver with an “S” shaped profile;

FIG. 7E is a dimensional cross-sectional view of an alternative embodiment louver with a curved profile and rib;

FIG. 7F is a dimensional cross-sectional view of a second alternative embodiment louver with a curved profile and rib;

FIG. 7G is a dimensional cross-sectional view of an alternative embodiment louver with a straight profile and rib, as shown in FIG. 3; and

FIG. 7H is a dimensional cross-sectional view of a preferred embodiment of the louver of the invention.

### DETAILED DESCRIPTION OF THE INVENTION

The following description is intended to convey a thorough understanding of the embodiments by providing a number of specific embodiments and details involving a siding panel assembly. It is understood, however, that the invention is not limited to these specific embodiments and details, which are exemplary only. It is further understood that one possessing ordinary skill in the art, in light of known devices, systems and methods, would appreciate the use of the invention for its intended purposes and benefits in any number of alternative embodiments.

As used herein, the directional terms, such as, “horizontal”, “vertical”, “upper” and “lower” are not intended to be limited to a specific orientation. The references of the directional terms as described in one embodiment of the invention are intended to continue to reference the respective axis, surface and/or direction in other embodiments where the louver may be provided in another orientation relative to the ground or horizon.

Shown in FIG. 1 is a cross section of a portion of a shutter assembly 100 with shutter 110 having standard louvers 101 of the prior art installed at standard intervals vertically. These prior art louvers 101 have an elongated oval shape with a centered attachment pin/pivot point 102.

FIG. 2A and FIG. 2B is a cross section of a portion of a shutter assembly 200 with shutter 210 having louvers 201 of a preferred embodiment of the invention installed at standard intervals vertically. The louvers 201 of preferred embodiments of the invention have a thicker oval shape with an offset attachment pin/pivot point 202.

FIG. 3 is a cross section of a portion of a shutter assembly 300 with shutter 310 having louvers 301 of an alternative embodiment of the invention installed at standard intervals vertically. The louvers 301 of this alternative embodiment of the invention have an elongated oval shape similar to prior art louver 101, but with an offset attachment pin/pivot point 202 at least partially disposed in a protruding rib 303.

In louvers 201 of the preferred embodiment of the invention, the cross sectional geometry may retain a traditional oval shape, but, as shown in FIG. 4, the thickness 204 shall be increased by increasing the upper and/or lower surface radii 209 in order to increase the moment of inertia, while maintaining a width 203 and edge radii 205 similar to those of prior art louver 101. The thickness 204 may be increased but the amount of increase shall be constrained in order to retain a visual ascetic that is not obviously different from a traditional louver 101 once louver 201 is installed into a shutter assembly 210. The attachment pin/pivot point 202 may be moved from the neutral axis of the louver, towards the edge of the profile in order to further increase the moment of inertia.

As mentioned earlier in this specification the maximum deflection of a louver may be described by the beam equation:

y=WL³/384EI

The schematic diagram 500 in FIG. 5, shows a beam 502 with fixed ends 504 attached between supports 503 spanning a length 506 while under a distributed load 501. As the distributed load 501 and/or the length 506 increases, the amount of sag at the center point 505 increases. Given samples with the same length 506 and modulus of elasticity (“E”), the amount of sag at the center point 505 of a beam can be improved by increasing its Moment of Inertia (“I”).

The moment of inertia (“I”) of a beam can be changed by modifying its cross sectional profile. Three different profiles are shown in FIGS. 6A, 6B and 6C. FIGS. 6A is a cross-sectional profile view of the prior art louver 101 with a modulus of elasticity of 191,023 psi. The moment of inertia through the horizontal axis of symmetry 108 is 0.016 lb*in², giving the prior art louver 101 a calculated stiffness (“EI”) of 3,056 lbs/inch.

By increasing the thickness of the louver 601 with the same modulus of elasticity, the moment of inertia through the horizontal axis of symmetry 608 increases to 0.029 lb*in², giving louver 601 an EI of 5,540 lbs/inch, a 81% increase over prior art louver 101.

Preferred embodiments of the louver 201, may further increase the moment of inertia at the same modulus of elasticity by shifting the attachment pin/pivot point 202 from the horizontal axis of symmetry 208 to an offset parallel axis 206 below the horizontal axis of symmetry 208 and perpendicular to the vertical axis of symmetry 207. By doing this, the moment of inertia is measured through the offset parallel axis 206, and is further increased to 0.049 lbₘ*in² giving louver 201 an EI of 9,360 lbs/inch, a 206% increase over prior art louver 101.

A further advantage of the preferred embodiment louvers 201, is that the distance 211 from the attachment pin 202 to the lower outside surface of the louver 201 may be the same as the distance from the attachment pin 102 to the lower outside surface of the prior art louver 101. This allows the holes for the attachment pin 202 drilled in the same set up as the prior art louver 101, while alternative embodiment louver 601 has a further distance 611 between the attachment pin 602 and the nearest outside surface, may require the drill and/or jig (not shown)to be adjusted from the standard position to accommodate the new distance 611.

FIGS. 7A through 7H show the comparative dimensions of various louver cross sections of the prior art and embodiments of the invention. The louver 101 of FIG. 7A is a prior art louver 101 with a standard width 103 of 3.5 inches, and a standard thickness 104 of 0.437 inches, with a calculated sag of 0.038 inches for a 36 inch span. The alternative embodiment louver 701b of FIG. 7B has a standard width 703b of 3.5 inches, and a standard thickness 704b of 0.437 inches, but further includes a casement/skin 722b reinforcing the louver to improve resistance to sagging, with a calculated sag of 0.031 inches for a 36 inch span. The alternative embodiment “S-profile” louver 701c of FIG. 7C has a width 703c of 3.451 inches, and a thickness 704c of 0.578 inches, The “S-profile” may improve resistance to sagging, with a calculated sag of 0.025 inches for a 36 inch span. The alternative embodiment wide “S-profile” louver 701d of FIG. 7D has a width 703d of 4.146 inches, and a thickness 704d of 0.527 inches, The “S-profile” may improve resistance to sagging, with a calculated sag of 0.032 inches for a 36 inch span. The alternative embodiment “curve and rib” profile louver 701e of FIG. 7E has a width 703e of 3.623 inches, and a thickness 704E of 0.551 inches, The “curve and rib” may improve resistance to sagging, with a calculated sag of 0.022 inches for a 36 inch span. The alternative embodiment “curve and rib” profile louver 701f of FIG. 7F has a width 703f of 3.499 inches, and a thickness 704e of 0.532 inches, The “curve and rib” may improve resistance to sagging, with a calculated sag of 0.021 inches for a 36 inch span. The alternative embodiment “offset pivot with rib” profile louver 301 of FIG. 7G has a width 303 of 3.359 inches, and a thickness 304 of 0.579 inches, The “offset pivot with rib” may improve resistance to sagging, with a calculated sag of 0.014 inches for a 36 inch span. The preferred embodiment louver 201 of FIG. 7G includes a thicker profile with an offset pivot point has a width 203 of 3.279 inches, and a thickness 204 of 0.572 inches, with a calculated sag of 0.017 inches for a 36 inch span, while maintaining a desirable shape similar to that of the prior art louver 101.

Preferred embodiments of the louvers of the invention may have an elongated oval shape with a thickness 204 to width 203 ratio between 0.14 and 0.25.

In addition to altering the profile shape of the louver to improve the moment of inertia to improve resistance to sagging, the composition and density of the PVC plastic may be modified to improve the modulus of elasticity to further increase resistance to weight sag and/or prevent or minimize thermal sag.

In embodiments of the invention the modulus of elasticity may be increased by creating a composite material of PVC and other thermoset plastics such as styrene, acrylic, styrene-acrylonitrile (SAN), alpha-methyl styrene-acrylonitrile (AMSAN), and/or chlorinated PVC (CPVC). Other compound modifiers that may be used in the composite material PVC include acrylonitrile, alkyl methacrylate, butadiene, acrylonitrile-butadiene-styrene, chlorinated poly-ethylene may also be used. The ratios of the compound modifiers in the composite material may be in ratios varying from 10 parts modifier per hundred parts resin (“phr”) to 40 parts modifier phr.

In addition, mineral fillers may be used in some embodiments, such as titanium dioxide, calcium carbonate, and talc in ratios varying from 10 parts mineral filler phr to 40 parts mineral filler phr.

Further, in some embodiments, the specific gravity of the cellular PVC louver profile may be controlled so that its effect on the modulus of elasticity and its effect on load (the louver's own weight due to gravity) such that the combination of W, E and I in the beam stress and deflection equations result in an acceptable deflection of the louver once installed into a shutter panel. The specific gravity for preferred embodiments of the louver are between 0.50 and 0.70.

As the specific gravity of the material increases, the modulus of elasticity of the material also increases, thus decreasing deflection, but as specific gravity increases, the louver's weight also increases, thus increasing deflection. The relationship of the rate of change of weight and modulus as specific gravity increases may vary based upon the specific material selected, and therefore each specific PVC composite material will result in a unique, optimum specific gravity to minimize deflection. The specific gravity of the PVC compounds used in preferred embodiments of the louver may be between 0.50 and 0.70.

Since there are four variables that influence the final result a large change in one variable may permit a small change in other variables to have each scenario arrive at the same level of performance for different embodiments of the invention. Hence, there can be “windows of operation” for each variable, but not all combination of conditions within the window for each variable will result in an acceptable solution. This permits the selection of conditions that result in optimal costs.

For example one embodiment may utilize a very expensive material that can be used at a low density or a thinner geometry where another embodiment may use a lower cost material that requires a high specific gravity or thicker profile.

For one embodiment the target criteria may be to fabricate a shutter assembly that can span a standard 36 inch window with a single shutter. The estimated span length of the louver required to create a 36 inch panel is 32 inches. The total panel width is about 4 inches larger than the louver span because the stiles (side rails) are each about 2 inches wide. The widest panel made with the existing louver designs is a 32 inch panel which uses a 28 inch louver span.

In a further embodiment the goal may be to design a louver with a 32 inch span that would have the same or less deflection as the existing louver products with a 28 inch span. The target acceptable deflection for the louver profile under its own weight is between 0.015 inches to 0.020 inches to maintain an acceptable visual aesthetic.

Design conditions for one embodiment of a wide span louver of the invention may include:
a wide span louver profile maximum thickness of 0.50 inches to 0.875 inches (12.5 mm-21.5mm);
a wide span louver profile pivot point offset from the horizontal axis by 0.094 inches to 0.219 inches (2.4 mm-5.6mm); and
a modulus of elasticity of the PVC compound of 190,000 and 250,000 psi (1,310 MPa-1,724 MPa)

The target modulus of elasticity for a PVC/AMSAN compound that may be used in some embodiments is between 190,000 and 250,000 psi (1,310 MPa-1,724 MPa) depending upon combination of modulus and specific gravity, and resulting cost of the selected formulation. Higher loadings of AMSAN may result in higher modulus allowing for a lower density, but the higher loading may result in higher cost per pound of raw material.

Preferred embodiments of louvers of the invention have a density between 0.48 g/cm³ and 0.66 g/cm³.

In the preceding specification, various preferred exemplary embodiments have been described with reference to the accompanying drawings. It will, however, be evident that various modifications and changes may be made thereto, and additional exemplary embodiments may be implemented, without departing from the broader scope of the invention as set forth in the claims that follow. The specification and drawings are accordingly to be regarded in an illustrative rather than restrictive sense.

What we claims is:

1. A wide span louver having a louver width at its widest point and a louver thickness at its thickest point, and the ratio of the louver thickness to the louver width is in the range of 0.14 to 0.25.

2. The wide span louver of claim 1, further comprising a pivot point disposed below a plane representing the louver width.

3. The wide span louver of claim 2, wherein the pivot point is disposed on a plane representing the louver thickness.

4. The wide span louver of claim 3, further comprising a upper outer surface and a lower outer surface, wherein a pivot point of the louver is closer to the lower outer surface of the louver.

5. The wide span louver of claim 1, wherein the cross-sectional shape of the louver includes a convex top surface and a convex bottom surface.

6. The wide span louver of claim 5, wherein the convex top surface and convex bottom surface are connected by a front edge radius surface and a rear edge radius surface.

7. The wide span louver of claim 1, where in the louver is comprised of poly-vinyl chloride composite compounds, and is free of reinforcing inserts.

8. The wide span louver of claim 1, wherein a specific gravity of the louver is between 0.50 and 0.70.

9. The wide span louver of claim 1, wherein a density of the louver is between 0.48 g/cm³ and 0.66 g/cm³.

10. The wide span louver of claim 1, wherein a modulus of elasticity of the louver is between 190,000 psi and 250,000 psi.
